(19) United States
(12) Patent Application Publication
(10) Pub. No.: US 2011/0097122 A1
(43) Pub. Date: Apr. 28, 2011

(54) FIXING DEVICE, IMAGE FORMING APPARATUS

(76) Inventor: Masami OKAMOTO, Yamato city (JP)

(21) Appl. No.: 12/897,254

(22) Filed: Oct. 4, 2010

(30) Foreign Application Priority Data
Oct. 27, 2009 (JP) 2009-246586

(51) Int. Cl. G03G 15/20

(52) U.S. Cl. 399/329

(57) ABSTRACT

A fixing device includes a rotatable fixing member, a pressing member in contact with the fixing member, and a pressure application-release device. The pressure application-release device has a pressing cam to pressurize a first pressing arm, a second pressing arm to pressurize the pressing member, a compression spring to connect the first pressing arm with the second pressing arm, and a motor to turn the pressing cam. The pressure application-release device switches a state of the pressing member between a pressure application state to contact the pressing member against the fixing member and a pressure release state to separate the pressing member from the fixing member.

### PRIORITY STATEMENT

The present patent application claims priority to Japanese Patent Application No. 2009-246586, filed on Oct. 27, 2009, in the Japan Patent Office, which is hereby incorporated by reference in its entirety.

### BACKGROUND OF THE INVENTION

1. Field of the Invention

Example embodiments generally relate to a fixing device, an image forming apparatus, and an image fixing method, and more particularly, to a fixing device, an image forming apparatus including the fixing device, and an image fixing method for fixing a toner image on a recording medium.

2. Description of the Related Art

Related-art image forming apparatuses, such as copiers, facsimile machines, printers, or multifunction printers having at least one of copying, printing, scanning, and facsimile functions, typically form an image on a recording medium (e.g., a sheet) according to image data using electrophotography. Thus, for example, a charger uniformly charges a surface of an image carrier and an optical writer emits a light beam onto the charged surface of the image carrier to form an electrostatic latent image on the image carrier according to the image data. A development device supplies toner particles to the electrostatic latent image formed on the image carrier to make the electrostatic latent image visible as a toner image, and the toner image is directly transferred from the image carrier onto a sheet or is indirectly transferred from the image carrier onto a sheet via an intermediate transfer member. A cleaner then cleans the surface of the image carrier after the toner image is transferred from the image carrier onto the sheet. Finally, a fixing device applies heat and pressure to the sheet bearing the toner image to fix the toner image on the sheet, thus forming the image on the sheet.

Certain known fixing devices include a fixing roller and a pressing roller facing each other that function as a heating member and a pressing member, respectively. These rollers press against each other to form a fixing nip through which the sheet of recording medium is passed. In this fixing device, when the sheet passes between the fixing roller and the pressing roller, the image is fixed on the sheet with heat and pressure by fusing the unfixed image.

Alternatively, in other fixing devices, in order to shorten a warm-up time period of the fixing device, an endless fixing belt is often used as the heating member.

The fixing device loops an endless fixing belt around a fixing roller and a heating roller in such a manner that the fixing roller and the heating roller apply a reference tension to the fixing belt. A pressing roller rotates and presses against the fixing belt and the fixing roller to form a fixing nip portion between the fixing belt and the pressing roller. A heater is disposed inside the heating roller, and heats the fixing belt via the heating roller. The fixing belt and the pressing roller apply heat and pressure to a sheet bearing a toner image at the fixing nip portion to fix the toner image on the sheet.

In general, the fixing roller and the pressing roller have an elastic layer on a cylindrical metal core. When a pressure at the fixing nip portion has been maintained for a long term with the fixing roller and the pressing roller stopped, a permanent deformation is caused in the elastic layers of the fixing roller and the pressing roller, even if the pressing roller is separated from the fixing roller.

### SUMMARY OF THE INVENTION

At least one embodiment may provide a fixing device that includes a rotatable fixing member, a pressing member in contact with the fixing member, and a pressure application-release device. The pressure application-release device has a pressing cam to pressurize a first pressing arm, a second pressing arm to pressurize the pressing member, a compression spring to connect the first pressing arm with the second pressing arm, and a motor to turn the pressing cam. The pressure application-release device switches a state of the pressing member between a pressure application state to contact the pressing member against the fixing member and a pressure release state to separate the pressing member from the fixing member.

At least one embodiment may provide an image forming apparatus that includes an image carrier, a charging device to charge the image carrier uniformly, an exposure device to expose the charged surface of the image carrier and form a latent image on the image carrier. There is a developing device to visualize the latent image formed on the surface of the image carrier, a transfer device to transfer the visualized image onto a recording medium directly or indirectly via an intermediate transfer member, and the fixing device described above to fix the image on a sheet of recording medium.

Additional features and advantages of example embodiments will be more fully apparent from the following detailed description, the accompanying drawings, and the associated claims.

### BRIEF DESCRIPTION OF THE DRAWINGS

A more complete appreciation of example embodiments and many of the attendant advantages thereof will be readily obtained as the same becomes better understood by reference to the following detailed description when considered in connection with the accompanying drawings, wherein:

FIG. 1 is a sectional view of an image forming apparatus according to an example embodiment;

FIG. 2 is a sectional view (according to an example embodiment) of a fixing device included in the image forming apparatus shown in FIG. 1;

FIG. 3 is a sectional view of a pressure application state of the fixing device;

FIG. 4 is a schematic view showing a motor and a gear train in a pressure application-release device of FIG. 3;

FIG. 5 is a sectional view (according to an example embodiment) of the pressure application-release device included in the fixing device shown in FIG. 2;

FIG. 6 is a sectional view of a pressure release state of the fixing device; and

FIG. 7 is a sectional view showing another embodiment in the fixing device of this invention.

The accompanying drawings are intended to depict example embodiments and should not be interpreted to limit the scope thereof.

### DETAILED DESCRIPTION OF EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

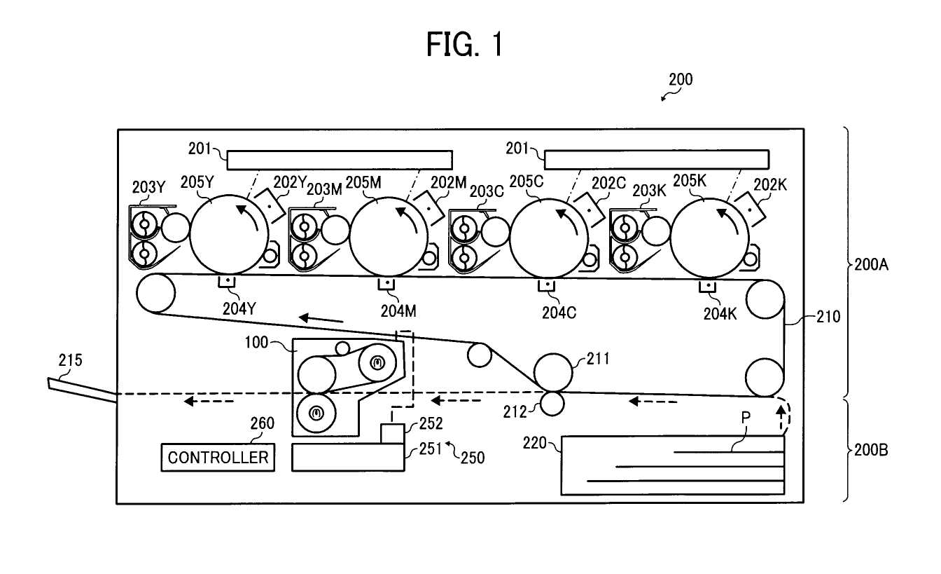

Referring now to the drawings, wherein like reference numerals designate identical or corresponding parts throughout the several views, particularly to FIG. 1, an image forming apparatus 200 according to an example embodiment is explained. As illustrated in FIG. 1, the image forming apparatus 200 includes an image forming device 200A, a sheet supplier 200B, a stacker 215, and a controller 260.

The image forming device 200A includes optical writers 201 (e.g., lasers and rotating polygonal mirrors), chargers 202Y, 202M, 202C, and 202K, development devices 203Y, 203M, 203C, and 203K, first transfer devices 204Y, 204M, 204C, and 204K, photoconductors 205Y, 205M, 205C, and 205K, a transfer belt 210, a roller 211, a transfer roller 212, a fixing device 100, and/or an oil circulation mechanism 250. The sheet supplier 200B includes a paper tray 220. The oil circulation mechanism 250 includes an oil tank 251 and an oil pump 252. The image forming apparatus 200 can be a copier, a facsimile machine, a printer, a plotter, a multifunction printer having at least one of copying, printing, scanning, plotter, and facsimile functions, or the like. According to this example embodiment of the present invention, the image forming apparatus 200 functions as a multi-color copier for forming a color image on a recording medium at high speed by electrophotography.

The image forming device 200A is provided at a center portion of the image forming apparatus 200. The sheet supplier 200B is provided under the image forming device 200A.

An image reader such as a scanner is provided above the image forming device 200A.

In the image forming device 200A, the transfer belt 210 includes a transfer surface extending in a horizontal direction. A mechanism for forming an image in a complementary color which is complementary to a separation color is provided above the transfer belt 210. For example, the photoconductors 205Y, 205M, 205C, and 205K, serve as image carriers for carrying toner images in complementary colors (e.g., yellow, magenta, cyan, and black), and are arranged along the transfer surface of the transfer belt 210.

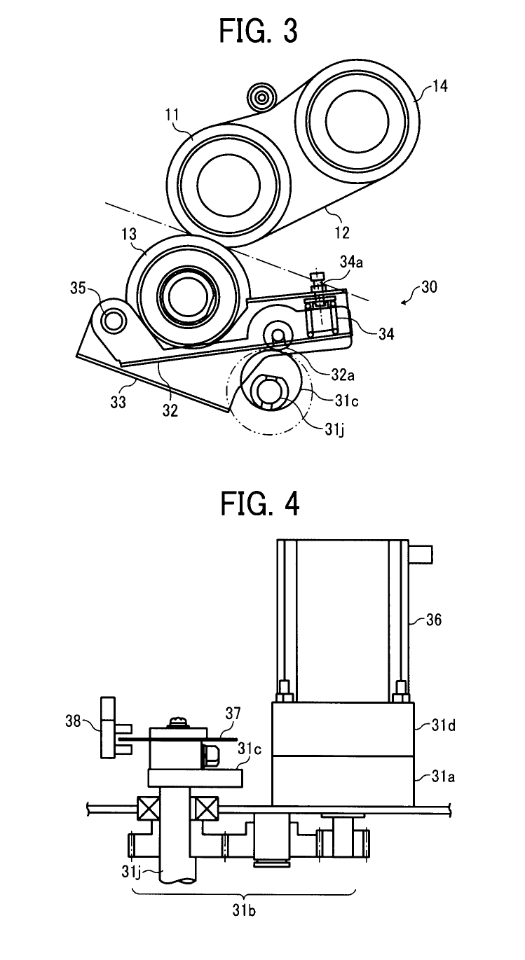

The photoconductors 205Y, 205M, 205C, and 205K are formed of photoconductive drums which rotate in a same direction (e.g., counterclockwise in FIG. 3), respectively. The optical writers 201, the chargers 202Y, 202M, 202C, and 202K, the development devices 203Y, 203M, 203C, and 203K, the first transfer devices 204Y, 204M, 204C, and 204K, and cleaners surround the photoconductors 205Y, 205M, 205C, and 205K, respectively, to perform image forming processes while the photoconductors 205Y, 205M, 205C, and 205K rotate. The development devices 203Y, 203M, 203C, and 203K contain yellow, magenta, cyan, and black toner, respectively.

The transfer belt 210 is looped over a driving roller and driven rollers, and opposes the photoconductors 205Y, 205M, 205C, and 205K to move in a direction corresponding to the direction of rotation of the photoconductors 205Y, 205M, 205C, and 205K. The transfer roller 212 opposes the roller 211 serving as a driven roller.

In the sheet supplier 200B, the paper tray 220 contains sheets P serving as a recording medium. A conveyance mechanism feeds the sheets P loaded on the paper tray 220 one by one toward the transfer roller 212. For example, the conveyance mechanism separates an uppermost sheet P from other sheets P loaded in the paper tray 220, and conveys the sheet P toward the transfer roller 212. A conveyance path provided between the transfer roller 212 and the fixing device 100 conveys the sheet P in a horizontal direction. The controller 260 controls operations of the image forming apparatus 200 and may be implemented as a programmed microprocessor or an application specific integrated circuit, for example.

The following describes image forming operations performed by the image forming apparatus 200. The charger 202Y uniformly charges a surface of the photoconductor 205Y. The optical writer 201 forms an electrostatic latent image on the charged surface of the photoconductor 205Y according to image data sent by the image reader. The development device 203Y which uses the yellow toner develops the electrostatic latent image formed on the photoconductor 205Y visible as a yellow toner image. The first transfer device 204Y applies a reference bias to the yellow toner image formed on the photoconductor 205Y to transfer the yellow toner image onto the transfer belt 210. Similarly, magenta, cyan, and black toner images are formed on the photoconductors 205M, 205C, and 205K, respectively, and sequentially transferred onto the transfer belt 210 by an electrostatic force so that the yellow, magenta, cyan, and black toner images are superimposed on the transfer belt 210 to form a color toner image on the transfer belt 210.

The transfer roller 212 transfers the color toner image from the transfer belt 210 onto the sheet P conveyed by the roller 211 and the transfer roller 212. The sheet P bearing the color toner image is further conveyed to the fixing device 100. The fixing device 100 fixes the color toner image on the sheet P. The sheet P bearing the fixed color toner image is sent to the stacker or output tray 215 via an output path. The oil tank 251 collects oil used in the fixing device 100 to improve the separating of the sheet P from the fixing device 100. The oil pump 252 resupplies oil contained in the oil tank 251 to the fixing device 100. The oil tank 251 and the oil pump 252 serve as the oil circulation mechanism 250 (e.g., an oil circulation system) provided for the fixing device 100.

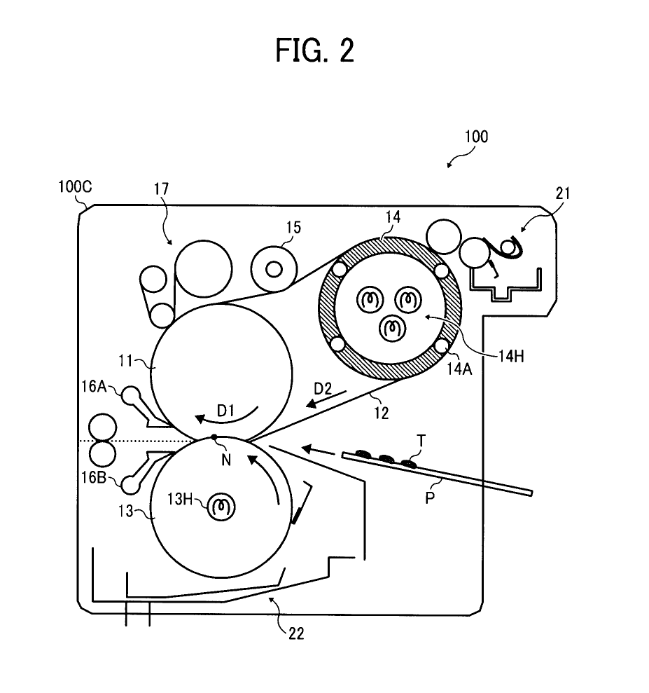

FIG. 2 is a sectional view of the fixing device 100. The fixing device 100 includes a fixing cover 100C, a fixing roller 11, a fixing belt 12, a pressing roller 13, a heating roller 14, a heat pipe 14A, a heater 14H, a tension roller 15, separation devices or claws 16A and 16B, a cleaning mechanism 17, and oil appliers 21 and 22.

The fixing roller 11, the fixing belt 12, the pressing roller 13, the heating roller 14, the separation claws 16A and 16B, and the cleaning mechanism 17 are provided inside the fixing cover 100C. The fixing belt 12, serving as a fixing member, is looped or stretched over the fixing roller 11 and the heating roller 14 with a reference tension. The pressing roller 13, serving as a pressing member, is provided under the fixing belt 12 and presses against the fixing belt 12 to form a fixing nip portion N between the fixing belt 12 and the pressing roller 13. The fixing belt 12 and the pressing roller 13 apply heat and pressure to a sheet P bearing a toner image T at the fixing nip portion N to fix the toner image T on the sheet P. The separation claw 16A is provided at an exit side of the fixing nip portion N in such a manner that a head of the separation claw 16A contacts or is disposed close to the fixing belt 12, so as to prevent a sheet P from wrapping around the fixing belt 12. The separation claw 16B is provided at the exit side of the fixing nip portion N in such a manner that a head of the separation claw 16B contacts the pressing roller 13, so as to prevent a sheet P from wrapping around the pressing roller 13. The cleaning mechanism 17 cleans the fixing belt 12 by pressing a cleaning web against the fixing belt 12.

The fixing belt 12 has an endless belt shape and has a double-layer structure in which an elastic layer, such as a silicon rubber layer, is formed on a base including nickel, stainless steel, and/or polyimide.

The following fixing belt can be used in place of the above-mentioned fixing belt 12. A fixing belt has a thickness of 2 mm or thinner and includes a base layer, an elastic layer, and a release layer. The respective layers of the fixing belt are described below.

The base layer has a layer thickness of within a range from 30 μm to 500 μm, for example. Examples of a material of the base layer include, but is not limited to, metal such as nickel and stainless steel; and resin such as polyimide.

The elastic layer has a layer thickness of within a range from 100 μm to 1450 μm and can be formed with rubber. Examples of a material of the elastic layer include, but is not limited to, silicone rubber, foamed silicone rubber, and fluorine-containing rubber. Providing the elastic layer in the fixing belt can prevent or reduce minute asperities created on an outer surface of the fixing belt in the fixing nip, and thus heat can be uniformly transmitted to a toner image T on the sheet P. If heat is unevenly transmitted to the toner image, a fixed image will be a so-called orange-peel image, which means an image whose surface is irregular or grainy like the surface of oranges. Thus, providing the elastic layer in the fixing belt can prevent or reduce orange-peel images.

The release layer has a thickness within a range from 10 μm to 100 μm, for example. Examples of a material of the release layer include, but not limited to, tetrafluoroethylene-perfluoro (alkyl vinyl ether) copolymer (PFA), polytetrafluoroethylene (PTFE), polyimide, polyether imide, polyether sulfide (PES). Providing the release layer can give the fixing belt 21 toner releasability.

The endless fixing belt can have a diameter of within a range from 15 mm to 400 mm, for example.

The fixing roller 11 includes metal serving as a core metal and silicon rubber. In order to shorten a warm-up time period of the fixing device 100, the fixing roller 11 may include foamed silicon rubber so that the fixing roller 11 does not absorb heat from the fixing belt 12 easily.

The heating roller 14 is a hollow roller including aluminum or iron. The heater 14H, such as a halogen heater, serves as a heat source and is provided inside the heating roller 14. Alternatively, an induction heating (1H) mechanism may serve as the heat source. A plurality of heat pipes 14A, which are hollow pipes, for example, are provided in a thick wall of the heating roller 14. For example, the heat pipes 14A are embedded in the thick wall of the heating roller 14 in such a manner that the heat pipes 14A are evenly spaced in a circumferential direction of the heating roller 14 and that a longitudinal direction of the heat pipes 14A corresponds to a longitudinal direction (e.g., a width direction or an axial direction) of the heating roller 14. The heat pipes 14A improve heat transmission from the heater 14H to a surface of the heating roller 14, and thereby the heating roller 14 uniformly heats the fixing belt 12 quickly.

When the fixing device 100 is driven, a driving force input from an outside of the fixing device 100 drives and rotates the pressing roller 13 counterclockwise in FIG. 2, for example. Accordingly, the rotating pressing roller 13 rotates the fixing roller 11 clockwise in FIG. 2 in a direction of rotation D1 via the fixing belt 12. For example, in a state in which the tension roller 15 presses against the fixing belt 12 to apply proper tension to the fixing belt 12, the fixing belt 12 rotates clockwise in FIG. 2 in a direction of rotation D2 and feeds a sheet P out of the fixing nip portion N. In order to fix a toner image T on a sheet P, the heater 14H provided inside the heating roller 14 generates heat to heat the fixing belt 12 until a temperature sensor such as thermistor nor or contacting the fixing belt 12 detects that the fixing belt 12 is heated up to a reference temperature (e.g., a proper fixing temperature). According to this example embodiment, the fixing belt 12 which is an endless belt, serves as a fixing member. Alternatively, a fixing roller, for example, a hollow cylindrical roller may serve as a fixing member.

The pressing roller 13 is a cylindrical roller in which an elastic layer including silicon rubber is provided on a core metal including aluminum or iron. The heater 13H is provided inside the pressing roller 13, and generates heat to heat the pressing roller 13 up to a reference temperature as needed, for example, to fix a toner image T on a sheet P.

In the fixing device 100, the oil appliers 21 and 22 apply a proper amount of oil to the fixing belt 12 and the pressing roller 13, respectively, and the separation claws 16A and 16B which are provided at the exit side of the fixing nip portion N function as needed. Thus, a sheet P can be discharged to the exit side of the fixing nip portion N without adhering to or wrapping around the fixing belt 12 or the pressing roller 13.

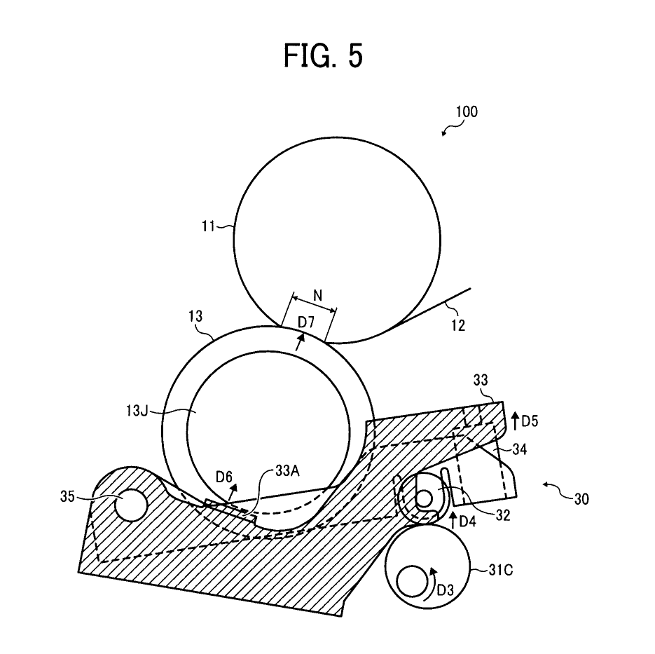

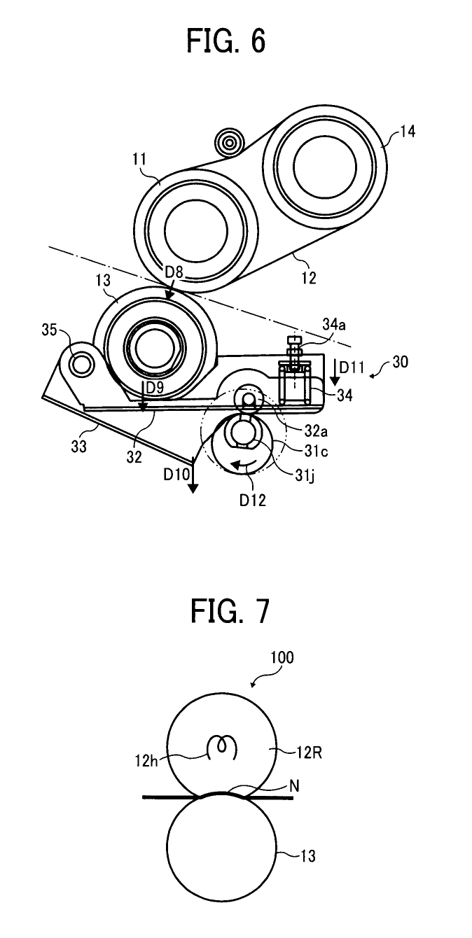

Embodiments will now be described with respect to FIGS. 3 to 6. FIG. 3 is a side view of a pressure release state of a pressure application-release device. FIG. 4 shows a motor and a gear train when viewed from above the fixing device. FIG. 5 is a sectional view of the pressure application-release device. FIG. 6 is a side view of a pressure release state of the pressure application-release device.

Referring to FIGS. 3 to 6, the pressure application-release device 30 includes a first pressing arm 32, a second pressing arm 33, a compression spring 34, a support shaft 35, a pressing eccentric cam 31c, and a motor 36.

The first pressing arm 32 has a fulcrum end, a contact end and a cam follower 32a. The first pressing arm 32 is provided with the support shaft 35 in the fulcrum end so that the first pressing arm 32 turns on the support shaft 35. The cam follower 32a is formed in the shape of a roller. The cam follower 32a is provided with side walls of the first pressing arm 32 so that the cam follower rotates while coming in contact with the pressing eccentric cam 31c. Preferably, an embodiment has the first pressing arm 32 at each side of the pressing roller 13, so that there are two pressing arms 32, although one or more than two can be used, if desired.

The second pressing arm 33 has a fulcrum end, a contact end and a pressing portion 33A. The second pressing arm 33 is provided with the support shaft 35 in the fulcrum end so that the second pressing arm 33 turns on the support shaft 35.

The pressing portion 33A is provided between the fulcrum end of the second pressing arm 33 and the contact end of the second pressing arm 33. The pressing portion 33A contacts and presses a bearing of a core shaft 13J. The second pressing arms 33 are provided in both the sides of the pressing roller 13.

The support shaft 35 is fixed to a frame of fixing device 100. The support shaft 35 supports the fulcrum ends of the first pressing arm 32 and the second pressing arm 33 so that the first pressing arm 32 and the second pressing arm 33 turn around the support shaft 35. The support shaft 35 can be split into two pivoting mechanisms and/or be two shafts provided at each side of the pressing roller 13.

The compression spring 34 is located between the contact end of the first pressing arm 32 and the contact end of the second pressing arm 33. The under side of the compression spring 34 is mounted on a bottom of the first pressing arm 32. The upper side of the compression spring 34 is fixed to a top of the second pressing arm 33 by a screw and a nut 34a. Thus, the compression spring 34 is sandwiched between the bottom of the first pressing arm 32 and the top of the second pressing arm 33. As the first pressing arm 32 pushes the compression spring 34 from the bottom, the compression spring 34 pushes the top of the second pressing arm 33. The compression spring 34 and associated mechanism is provided at each side of the pressing roller 13.

As shown in FIG. 6, a clearance is provided between the upper side of the compression spring 34 and the top of the second pressing arm 33. If the nut 34a is tightened, the clearance will become small. If the clearance becomes small, a force (pressure) at which the second pressing arm 33 pushes the pressing roller 13 will become strong. Moreover, the clearance will become large if the nut 34a is loosened. If the clearance is enlarged, the force (pressure) in which the second pressing arm 33 pushes the pressing roller 13 will become weak. Thus, the nut 34a can adjust the force (pressure) of the second pressing arm 33.

The pressing eccentric cam 31c is formed in the shape of a roller. A diameter of the pressing eccentric cam 31c is larger than a diameter of the cam follower 32a, for example.

The eccentric cams 31c are provided at both the sides of the pressing roller 13. The pressing eccentric cams 31c at each side are connected with a cam shaft 31j. The eccentric cams 31c on both sides synchronously turn by rotation of the cam shaft 31j. The cam shaft 31j is fixed to a position away from centers of the rollers of the eccentric cams 31c. The pressing eccentric cam 31c is in contact with the cam follower 32a. As the pressing eccentric cam 31c rotates, the pressing eccentric cam 31c pushes the cam follower 32a upwards and allows the cam follower 32a to drop downwards. The first pressing arm 32 links the movement of the eccentric cam 31c and the first pressing arm 32 turns on the support shaft 35.

As shown in FIG. 4, the motor 36 is connected with the eccentric cam 31c via a reduction gear 31a, a gear train 31b and cam shaft 31j. Electromagnetic clutch 31d is provided between the motor 36 and the reduction gear 31a. The electromagnetic clutch 31d transmits driving force of the motor 36 to the eccentric cam 31c at the time power is supplied to the motor 36 and intercepts drive transmission to the eccentric cam 31c from the motor 36 when power supply to the motor 36 is interrupted. The reduction gear 31a enlarges driving torque (driving force) of the motor 36 and the reduction gear 31a transmits the driving torque to the gear train 31b. The gear train is connected with an output shaft of the reduction gear 31a and the cam shaft 31j. The motor 36 is driven with electric power. And after rotating the eccentric cam 31c, the motor 36 is driven so that a rotation position which the eccentric cam 31c turned is held. As the result, the eccentric cam 31c stops after the cam 31c rotates, and the cam 31c is maintained at a stopping position (rotation position). It is desirable that a stepping motor is used as the motor 36. The stepping motor can drive the cam to a desired turning angle degree.

A rotary encoder has a disc 37 and an optical sensor 38 as shown in FIG. 4. The disc 37 is provided with the cam shaft 31j. The optical sensor 38 reads an angular position of the disc 37. The rotary encoder detects a phase of the eccentric cam 31c and the rotary encoder can detect the pressure application state and the pressure release state.

As a result, the pressure application-release device 30 can stop the motor 36 at any position among a pressure application state and a pressure release state based on the phase of the eccentric cam 31c read with the optical sensor 38. The pressure application state is a state in which the pressing roller 13 contacts the fixing belt 12 to apply pressure to the fixing belt 12. The pressure release state is a state in which the pressing roller 13 separates from the fixing belt 12 to release pressure applied to the fixing belt 12.

The pressure application-release device 30 switches a state of the pressing roller 13 between the pressure application state and the pressure release state.

Referring to FIG. 5, the following describes pressure application operations of the pressure application-release device 30 for applying pressure to the fixing belt 12 by moving the pressing roller 13 toward the fixing belt 12, and pressure release operations of the pressure application-release device 30 for releasing pressure applied to the fixing belt 12 by moving the pressing roller 13 away from the fixing belt 12.

The following describes the pressure application operations of the pressure application-release device 30.

Electric power is supplied to the motor 36, the motor 36 rotates, and a driving force of the motor 36 is transmitted to the cam shaft 31j through the gear train 31b. When the cam shaft 31j rotates, the pressing eccentric cam 31c turns by a reference angle of rotation in a direction of rotation D3, and the eccentric cam 31c pushes up the cam follower 32a of the first pressing arm 32 in a direction D4.

When the cam follower 32a of the first pressing arm 32 is pushed up, the first pressing arm 32 rotates about the support shaft 35 as a fulcrum counterclockwise in FIG. 5. Simultaneously, the compression spring 34 fixed to the bottom of the first pressing arm 32 also rotates to push up the top of the second pressing arm 33 with reference pressure in a direction D5.

The second pressing arm 33 is pushed up by a restoring force in which the compression spring 34 is extended to the direction of the second pressing arm 33 (in the direction D5).

When the top of the second pressing arm 33 is pushed up by the compression spring 34, the second pressing arm 33 rotates about the support shaft 35 counterclockwise in FIG. 5. Accordingly, the pressing portion 33A contacts the bearing of the pressing roller 13 to push the pressing roller 13 toward the fixing roller 11 in a direction D6.

The pressing roller 13 presses against the fixing roller 11 via the fixing belt 12, and applies reference pressure based on the restoring force of the compression spring 34 to the fixing roller 11 in a direction D7 to form the fixing nip portion N between the fixing belt 12 and the pressing roller 13.

The fixing nip pressure becomes the maximum at a position in which the compression cam 31c reached the top dead center.

Thus, when the fixing device 100 is driven, the pressure application-release device 30 presses the pressing roller 13 against the fixing belt 12 by pushing the pressing roller 13 toward the fixing belt 12 with the reference pressure. This pressure application state is maintained while the electric power is supplied to the motor 36. In addition, the fixing nip pressure can be adjusted with the nut 34a. If the nut 34a is tightened, the fixing nip pressure becomes strong. If the nut 34a is loosened, the fixing nip pressure becomes weak.

As illustrated in FIG. 2, when the pressing roller 13 contacts the fixing belt 12 in the pressure application state, the separation claw 16B contacts the pressing roller 13. In contrast, when the pressing roller 13 separates from the fixing belt 12 in the pressure release state, the separation claw 16B separates from the pressing roller 13.

According to this example embodiment, the pressing roller 13 having a roller shape serves as a pressing member. Alternatively, an endless belt looped over at least two rollers may serve as a pressing member.

In the fixing device 100, a surface of the fixing belt 12 is heated up to a reference temperature in a state in which the fixing belt 12 and the pressing roller 13 are driven and rotated. When a sheet P bearing an unfixed toner image T passes through the fixing nip portion N, that is, when the sheet P moves leftward in FIG. 4, the fixing belt 12 and the pressing roller 13 apply heat and pressure to the sheet P at the fixing nip portion N to melt and fix the unfixed toner image T on the sheet P.

When the sheet P bearing the fixed toner image T is discharged from the fixing nip portion N, the sheet P may adhere to or wrap around the fixing belt 12 or the pressing roller 13. To address this, the oil appliers 21 and 22 apply oil to the fixing belt 12 and the pressing roller 13 to improve property for separating the sheet P from the fixing belt 12 and the pressing roller 13, respectively. The applied oil may be heat-resistant fixing oil, such as silicon oil. When the head of the separation claw 16A or 16B contacts a leading edge of the sheet P, the separation claw 16A or 16B separates the sheet P from the fixing belt 12 or the pressing roller 13, respectively. The sheet P discharged from the fixing nip portion N passes through a discharge path and is sent out of the fixing device 100.

The following describes the pressure release operations of the pressure application-release device 30 for example, with respect to FIG. 5. When a driving force transmitted from the motor 36 rotates the pressing eccentric cam 31 further by a reference angle of rotation in the direction of rotation D3 from a position of the angle at which the pressing cam 31 causes the pressing roller 13 to press against the fixing roller 11 in the pressure application state, the pressing cam 31 releases pushing up the cam follower 32a of the first pressing arm 32 in a direction opposite the direction D4.

When pushing up the first pressing arm 32 is released, the first pressing arm 32 rotates about the support shaft 35 in a direction of rotation opposite the direction of rotation during the pressure application operations, that is, clockwise in FIG. 5, with a repulsive force transmitted through the fixing nip portion N, the pressing portion 33A, and the compression spring 34. Accordingly, the contact end of the second pressing arm 33 corresponding to the compression spring 34 is pulled together with the compression spring 34 by the restoring force of the spring 34 in a direction opposite the direction during the pressure application operations, that is, in a direction opposite the direction D5. Furthermore, the second pressing arm 33 is depressed by dead load (empty weight) of the pressing roller 13 and the second pressing arm 33.

When the contact end of the second pressing arm 33 for contacting the compression spring 34 is pulled down, the second pressing arm 33 rotates about the support shaft 35 in a direction of rotation opposite the direction of rotation during the pressure application operations, that is, clockwise in FIG. 5.

Accordingly, the pressing portion 33A, which is provided between the contact end and the fulcrum end of the second pressing arm 33, moves in a direction in which the pressing portion 33A separates from the core shaft 13J of the pressing roller 13 in a direction opposite the direction D6.

Thus, pressure applied by the pressing portion 33A to the pressing roller 13 is released, and the pressing roller 13 moves in a direction in which the pressing roller 13 separates from the fixing roller 11, that is, a direction opposite the direction D7. Accordingly, the fixing nip portion N is not formed between the fixing belt 12 and the pressing roller 13 in the pressure release state.

Thus, when driving of the fixing device 100 stops, the pressure application-release device 30 does not press the pressing roller 13 against the fixing belt 12, and the pressing roller 13 separates from the fixing belt 12 in the pressure release state.

The following describes the pressure release operations of the pressure application-release device 30 when the power supply to the motor 36 is interrupted, for example like a power failure.

As shown in FIG. 6, when the electric power supply to the motor 36 is interrupted in the pressure application state, either of at least a repulsive force from the fixing roller 11 to pressing roller 13 (in a direction D8) in the fixing nip portion or the dead load of the pressing roller 13 (in a direction D9), the dead load of the second pressing arm 33 (in a direction D10), and the restoring force of the compression spring 34 (in a direction D11) depresses (pushes back) the first pressing arm 32 so that the pressing roller 13 moves away from the fixing roller 11. And pressure application-release device 30 automatically released the fixing nip pressure.

In the pressure application operations, the repulsive force of the fixing roller 11 and the dead load of the pressing roller 13, the dead load of the second pressing arm 33, and the restoring force of the compression spring 34 have acted on the pressing eccentric cam 31c as a rotating torque that pushes back the first pressing arm 32, and rotates the pressing cam 31c reversely (in the direction D12). However, because the driving force (driving torque) of the motor 36 is applied to the pressing eccentric cam 31c in the pressure application state that the electric power is supplied to the motor 36, the pressing cam 31c resists the rotating torque and the rotation position of the cam 31c is fixed by the driving force of the motor 36 (the cam 31c is maintained at the rotation position by the driving force). The eccentric cam 31c balances the driving force (driving torque) of the motor 36 with the rotating torque. Therefore, the first pressing arm 32 is maintained at the position in the pressure application state.

However, the driving force (driving torque) of the motor 36 disappears when the power supply is interrupted for instance by the power failure and the power-off of the image forming apparatus 200. The disappearance of the driving force (driving torque) destroys the balance between the driving force and the rotating torque.

Therefore, the pressure release operation is executed automatically as the pressing eccentric cam 31c turns in the direction D12 by the rotating torque applied to the pressing cam 31c and without the driving force (driving torque) of the motor 36. As a result, a fixing nip pressure is released.

When the power failure occurs during printing operation, the pressure release operation cannot be performed by driving the motor 36. However, even when the motor 36 has stopped, the pressure application-release device 30 can automatically release the fixing nip pressure without driving the motor 36. For this reason, even when pressure release operation cannot be performed by driving the motor 36, permanent deformation of the fixing roller 11 and the pressing roller 13 can be prevented.

It is desirable in the pressure application state that the pressing eccentric cam 31c supports the first pressing arm 32 in the position except the top dead center.

It is because it becomes easy for the repulsive force of fixing roller 11 toward pressing roller 13 and the dead load of the pressing roller 13, the dead load of the second pressing arm 33, and the restoring force of the compression spring 34 to act on the pressing eccentric cam 31c as the rotating torque, when the eccentric cam 31c applies the pressure in the rotation position except the top dead center.

In addition, when the rotary encoder detects the phase of the pressing eccentric cam 31c, the eccentric cam 31c can be stopped in the position except the top dead center.

By the way, even when the power supply is interrupted as in the case of a power failure, the motor 36 has generally minute holding force that maintains the pressure application state.

Furthermore, when the pressure application-release device 30 has the reduction gear 31a for expanding the driving force (driving torque) of the motor 36, the holding force increases.

The rotating torque which acts on the eccentric cam 31c is the same as the holding force, or when smaller than the holding force, the eccentric cam 31c does not turn and the pressure release operation is not automatically performed. In order to prevent this problem, it is desirable to provide the electromagnetic clutch 31d between the motor 36 and the pressing eccentric cam 31c.

The holding force of the motor 36 comes not to be transmitted to the pressing eccentric cam 31c so that the electromagnetic clutch 31d separates driveline from the motor 36 when the power supply is interrupted such as the power failure. And the pressing eccentric cam 31c turns by the rotating torque that acts on the eccentric cam 31c and the pressure release operation is executed automatically.

Moreover, the pressure application-release device 30 can adjust the amount of movements of the first pressing arm 32 and the second pressing arm 33 by controlling the phase of the pressing eccentric cam 31c. Thereby the pressure application-release device 30 can adjust the fixing nip pressure.

Since the pressure application-release device 30 is equipped with the eccentric cam 31c, the pressure application-release device 30 can change the nip pressure in fixing nip N continuously with change of the phase of the eccentric cam 31c.

Then, the relation between the phase of the eccentric cam 31c and fixing nip pressure is beforehand recorded using the encoder. The desired fixing nip pressure can be set up by making a target phase of the cam 31c rotate the cam 31c based on the relation.

As for the pressure application-release device 30, when the kind and size of the recording medium to print are changed, it is desirable to control the phase of the pressing eccentric cam 31c and to adjust the fixing nip pressure. Thereby, correspondence to the sheet of various kinds and the sheet of the size is enabled from a thin paper to a tick paper.

The pressure application-release device 30 can control the pressure in the fixing nip so that the pressure in the warming-up state differs from the pressure under print (printing state). The pressure application-release device 30 can change the pressure in between the warming-up state and the printing state.

When the fixing device 100 fixes two or more sheets in one job, the pressure application-release device 30 can control the pressure in the fixing nip N so that the pressure when a paper is passing in the fixing nip N differs from the pressure when a paper is not existent in the fixing nip N (“when a paper is not existent in the fixing nip N” means is period after the back end of the paper passes fixing nip N until the tip of the following paper goes into fixing nip N.).

It is desirable to adjust the pressure in the fixing nip N so that a temperature rise of the pressing roller 13 is controlled. For example, when the paper has passed fixing nip N, it is desirable to increase the pressure of the pressing roller 13.

Heat from the fixing belt 12 is easily conducted to the pressing roller 13 when the pressure of the pressing roller 13 increases so that the contact area between the fixing belt 12 and the pressing roller 13 becomes large. Contrarily, the fixing belt 12 does not easily conduct heat to pressing roller 13 when the pressure of the pressing roller 13 decreases so that the area which the fixing belt 12 and the pressing roller 13 contact becomes small.

Thus, the temperature rise of the pressing roller 13 can be controlled by enlarging the pressure of the pressing roller 13 after the paper has passed fixing nip N. Moreover, the temperature rise of the pressing roller 13 can be controlled also by making the pressure of the pressing roller 13 small in a standby state.

Thus, the poor image such as the blistering of toner can be prevented by controlling the temperature rise of the pressing roller 13. The blister is a phenomenon which happens when forming an image on coated paper. The air of the gap between a toner and a toner or the gap between a toner and a coated paper expands within the fixing nip N, and air bubbles are generated in a toner layer on coated paper. Since breathability of a coated paper is bad, the air which is subjected to thermal expansion is shut up or trapped within the fixing nip N, and generates air bubbles in the toner layer.

FIG. 7 is a sectional view showing another embodiment of the fixing device of this invention.

The pressure application-release device 30 may be replaced with the fixing device 100 of FIG. 2, and may be used for a fixing device in which rollers contact each other and form the fixing nip N.

A fixing roller 12R and a pressing roller 13 contact directly and form the fixing nip N. The fixing roller 12R has a cylindrical metal core and an elastic layer on the core. A heater 12h such as a lamp, for example, is disposed inside the core of the fixing roller 12R. Since the composition of a pressing roller 13 is the same as previously described, an explanation of the pressing roller 13 is omitted.

Numerous additional modifications and variations are possible in light of the above teachings. For example, although the fixing device 100 is described as being incorporated in the multicolor printer 200 as shown in FIG. 1, the fixing device 100 is applicable to various types of electrophotographic image forming apparatus, such as monochrome printers, photocopiers, facsimiles, or multifunctional machines incorporating several of these imaging functions. It is therefore to be understood that, within the scope of the appended claims, the disclosure of this patent specification may be practiced otherwise than as specifically described herein.

What is claimed is:

1. A fixing device, comprising:
a rotatable fixing member to heat and melt a toner image on a recording medium;
a pressing member to contact the fixing member and form a fixing nip therebetween;
a pressure application-release device, including:
a first pressing arm which is pivotally supported;
a pressing cam to pressurize the first pressing arm;
a motor to turn the pressing cam;
a second pressing arm to pressurize the pressing member, and the second pressing arm being pivotally supported; and
a compression spring to connect the first pressing arm with the second pressing arm and to transmit a pressing force from the first pressing arm to the second pressing arm,
wherein the pressure application-release device switches a state of the pressing member between a pressure application state to contact the pressing member against the rotatable fixing member and a pressure release state to separate the pressing member from the rotatable fixing member.

2. The fixing device according to claim 1,
wherein the pressure application-release device maintains the pressure application state by a driving force of the motor.

3. The fixing device according to claim 1,
wherein the pressure application-release device causes the pressing member to shift to the pressure release state by a restoring force of the compression spring, when electric power supply to the motor is interrupted.

4. The fixing device according to claim 1,
wherein the pressing cam presses the first pressing arm in all positions except top dead center.

5. The fixing device according to claim 1, further comprising:
an electromagnetic clutch provided between the motor and the pressing cam,
wherein the electromagnetic clutch transmits driving force of the motor to the pressing cam at the time of power supply to the motor and intercepts drive transmission to the pressing cam from the motor when power supply to the motor is interrupted.

6. The fixing device according to claim 1, wherein the motor is a stepping motor.

7. The fixing device according to claim 1, further comprising:
an encoder to detect a phase of the pressing cam,
wherein the pressure application-release device adjusts the amount of movement of the first pressing arm by controlling the phase of the pressing cam.

8. The fixing device according to claim 1, wherein the pressure application-release device adjusts a pressure in the fixing nip to correspond to a kind and size of the recording medium.

9. The fixing device according to claim 1, wherein the pressure application-release device changes a pressure in the fixing nip at a time when the fixing device performs fixing of two or more consecutive sheets.

10. The fixing device according to claim 1, wherein the pressure application-release device changes a pressure in the fixing nip between a warming-up state and a printing state.

11. The fixing device according to claim 1, further comprising:
an endless fixing belt wound around the rotatable fixing member;
wherein the pressing member contacts the rotatable fixing member via the endless fixing belt.

12. The fixing device according to claim 1, wherein:
the first and second pressing arms are pivotally supported by a single shaft.

13. An image forming apparatus, comprising:
an image carrier;
a charging device to uniformly charge the image carrier,
an exposure device to expose the charged surface of the image carrier, forming a latent image on the image carrier;
a developing device to visualize the latent image formed on the surface of the image carrier;
a transfer device to transfer the visualized image onto a recording medium directly or indirectly via an intermediate transfer member, and
a fixing device to fix the image on a sheet of recording medium, the fixing device including:
a rotatable fixing member to heat and melt unfixed toner image on the sheet,
a pressing member in contact with the fixing member and formed a fixing nip therebetween,
a pressure application-release device, including:
a first pressing arm which is pivotally supported;
a pressing cam to pressurize the first pressing arm;
a motor to turn the pressing cam;
a second pressing arm to pressurize the pressing member, and the second pressing arm being pivotally supported; and
a compression spring to connect the first pressing arm with the second pressing arm and to transmit a pressing force from the first pressing arm to the second pressing arm,
wherein the pressure application-release device switches a state of the pressing member between a pressure application state to contact the pressing member against the rotatable fixing member and a pressure release state to separate the pressing member from the rotatable fixing member.

14. The image forming apparatus according to claim 13,
wherein the pressure application-release device causes the pressing member to shift to the pressure release state by a restoring force of the compression spring, when electric power supply to the motor is interrupted.

15. The image forming apparatus according to claim 13,
wherein the pressing cam presses the first pressing arm in all positions except top dead center.

16. The image forming apparatus according to claim 13, further comprising:
an electromagnetic clutch provided between the motor and the pressing cam,
wherein the electromagnetic clutch transmits driving force of the motor to the pressing cam at the time of power supply to the motor and intercepts drive transmission to the pressing cam from the motor when power supply to the motor is interrupted.

17. The fixing device according to claim 13, wherein:
the first and second pressing arms are pivotally supported by two shafts.

18. A fixing device, comprising:
a rotatable fixing member to heat and melt a toner image on a recording medium;
a pressing member to contact the fixing member and form a fixing nip therebetween; and
a pressure application-release device, including:
a first pressing arm which is pivotally supported;
a second pressing arm to pressurize the pressing member against the rotatable fixing member, the second pressing being pivotally supported and pressurizing the pressing member by a force from the first pressing arm; and
means for supplying a force which urges the first pressing arm towards the second pressing arm.

19. The fixing device according to claim 18, wherein:
the first and second pressing arms are pivotally supported by a same shaft.

20. The fixing device according to claim 18, wherein the means for supplying a force comprises an electric motor and a clutch.
